(19) United States
(12) Patent Application Publication
(10) Pub. No.: US 2003/0032723 A1
(43) Pub. Date: Feb. 13, 2003

(54) Films made from mixtures of polycarbonate and polystyrol

(76) Inventors: Hans-Leo Weber, Rommerskirchen (DE); Klaus Meyer, Dormagen (DE)

Correspondence Address: BAYER CORPORATION, PATENT DEPARTMENT, 100 BAYER ROAD, PITTSBURGH, PA, 15205, US

(21) Appl. No.: 10/182,606

(22) PCT Filed: Jan. 23, 2001
(86) PCT No.: PCT/EP01/00703

(30) Foreign Application Priority Data
Feb. 4, 2000 (DE) 100 05 037.9

(51) Int. Cl. C08G 63/48

(52) U.S. Cl. 525/55

(57) ABSTRACT

The invention relates to films made from mixtures of polycarbonate and polystyrol, the use thereof for manufacturing products made from said film, by stamping, a method for the manufacture of products made from films made from mixtures of polycarbonate and polystyrol, by stamping and the products obtained by the stamping of films made from mixtures of polycarbonate and polystyrol.

The present invention relates to films of mixtures of polycarbonate and polystyrene, the use of said films for the manufacture of products from said films by punching, a process for the manufacture of products from films of mixtures of polycarbonate and polystyrene by punching, and to products which may be obtained from films of mixtures of polycarbonate and polystyrene by punching.

The punching of plastics-films and plastics sheets is a frequently used process for the manufacture of parts for various applications such as, e.g., insulating parts in electrical apparatus, spacer discs, insertable parts, dials, screens or the like. In some cases, the punched edge is not visible because it is covered, e.g., by a frame so that no particular requirements are placed on the appearance of the punched edge. In other cases, however, the punched edge remains visible and must have an appropriate optical quality. This is the case, e.g., if windows are present in one part making it possible to see through to indicators or the like behind.

The punching of products from films may be carried out, for example, in such a manner that the product is cut out of the film by guiding an upper punch and a lower punch towards one another. The distance between the upper punch guided into the lower punch is known as the clearance.

A typical application is the dial face of the tachometer in a motor vehicle which often has a punched out window through which the indicator of kilometers travelled is visible behind it. The punched edge of said window must meet stringent optical requirements. Ideally, the sheared edge in the case of plane-parallel sheets should be at right angles to the surfaces and without any visible burr, and no filaments or fuzz should form during punching which might project into the window. Moreover, the edge must be smooth, i.e., the material should be sheared off cleanly during punching without flaking. These requirements are met only approximately by plastics with a high E modulus and low mechanical elongation.

Dials and screens in the motor vehicle are manufactured on a large scale from polycarbonate films. One reason for selecting this material is its toughness which ensures that the material does not shatter in the event of an accident. This may happen with brittle materials, and it is possible for sharp edges or dagger-like splinters to be formed, representing a potential source of injury for the passengers. This shattering is avoided by the desired toughness characteristic of polycarbonate but it is difficult to achieve the required optical quality of the punched edges.

Like many other well known plastics, for example, polyarylates, polyvinyl chloride, ABS, polyurethanes, polyolefins, cellulose esters, thermoplastic polyacrylates, polycarbonate also exhibits a so-called cold flow behaviour when mechanical stresses are applied during the punching process, with the result that plastics material flows into the cavity of the lower punch during punching. Due to this cold flow behaviour, the plastic is sheared off over a wide area of the thickness and not cut. The resulting sheared edges are fibrous and not clean.

The endeavours to solve this problem by using an increasingly narrow tolerance between the upper and lower punch did not bring about the desired success—at least for large production runs. An inspection at least, and optionally secondary finishing is therefore required. Another possibility is that of punching the window somewhat smaller in the first instance and in a second step producing an edge that satisfies the requirements by means of a so-called paring cut. Both secondary finishing and a second cut mean additional effort which is not required with materials having better punching properties.

One possibility of solving these problems lies in providing the polycarbonate with a mineral filler. Appropriate products are available commercially such as, e.g., Makrofol® BL from Bayer AG (Leverkusen, Germany). Mineral fillers cause scattering of the light passing through, however, which is a disadvantage because it reduces the transparency.

The object of the present invention is, therefore, to provide films which result in punched edges with high optical quality during punching. The good optical properties, for example, the high transparency and the good mechanical properties, for example, the high toughness of polycarbonate films should not be substantially impaired.

A further object of the present invention is to provide products which may be obtained from the films mentioned by punching.

The object according to the invention is achieved by films of mixtures of polycarbonate and polystyrene wherein the polystyrene proportion in the mixture must be selected within certain limits, and by products which may be obtained from said films by punching.

The present invention provides, therefore, a film of a mixture of polycarbonate and polystyrene, wherein the proportion of polystyrene in the mixture is 7 to 20 wt. %. The present invention also provides a multi-layer film, wherein at least one layer comprises a mixture of polycarbonate and polystyrene in which the proportion of polystyrene is 7 to 20 wt. %.

The present invention also provides the use of a film according to the invention for the manufacture of products from said films by punching.

The present invention also provides a process for the manufacture of products from films according to the invention by punching.

The present invention also provides a product which may be obtained from a film according to the invention by punching.

The present invention also provides a screen, a dial, an indicating dial, a dial face, a dial face of a vehicle tachometer or an insertable part which may be obtained from films according to the invention by punching.

The proportion of polystyrene in the mixture of polycarbonate and polystyrene is preferably 8 to 15 wt. %, particularly preferably 9 to 13 wt. %.

The films may be prepared by inherently known processes. For example, the films may be prepared by extrusion. The preparation of the films may be carried out, for example, according to the process described in DE-A 2 517 033 or in DE-A 2 531 240.

The films may be smooth on one side or on both sides, or matt or textured on one side or on both sides.

Multi-layer films in which at least one layer comprises the mixtures of polycarbonate and polystyrene according to the invention are suitable.

Suitable polycarbonates according to the invention are any polycarbonates. Bisphenol A homopolycarbonate is preferred according to the invention. Moreover, a copolycarbonate of bisphenol A and 1,1-bis-(4-hydroxyphenyl)-3,3,5-trimethylcyclohexane is preferred according to the invention.

Suitable polystyrenes according to the invention are any polystyrenes.

The mixture of polystyrene and polycarbonate according to the invention may contain conventional additives. For example, the mixture may contain lubricants, stabilisers, for example, UV stabilisers or processing stabilisers.

Moreover, the films may be coloured by suitable colorants to render them transparent or opaque.

The thickness of the films is preferably from 50 to 1,000 μm, particularly preferably from 150 to 800 μm and more particularly preferably from 250 to 600 μm. If the films according to the invention are multi-layer films, the thickness details given relate to the layers consisting of the mixture of polycarbonate and polystyrene according to the invention.

The films according to the invention have numerous advantages. Products with punched edges of high optical quality are obtained during punching. The films have good optical properties, particularly good transparency. The films have good mechanical properties, particularly good toughness. The films do not have a tendency to shatter in the event of a breaking stress.

The products according to the invention have numerous advantages. They are characterised by punched edges of high optical quality. They have good optical properties, particularly high transparency. The products according to the invention also have good mechanical properties, particularly high toughness. The products according to the invention do not have a tendency to shatter in the event of breaking stresses.

Mixtures of polycarbonate and polystyrene do not form physical mixtures but are present as a two-phase system. The elongation at break of standard polystyrene, that is, non impact-modified polystyrene, is max. 3%. The polystyrene phase is thus in the form of brittle particles in the tough polycarbonate matrix.

The optical refractive index of polystyrene is 1.5 and is thus the same as that of polycarbonate, namely 1.5. The embedded polystyrene particles are not, therefore, visible to the eye and the transparency remains intact. It is apparent, however, that with higher proportions of polystyrene in the polycarbonate the surfaces obtained are no longer optically perfect.

Surprisingly, the desired improvement in the punching properties was found with polystyrene contents in polycarbonate which do not yet impair the optical properties of the films in an unacceptable manner. These films do not have a tendency to shatter.

### EXAMPLES

A mixture of 90 parts of bisphenol A homopolycarbonate and 10 parts of polystyrene was prepared by compounding and processed in the known way by extrusion to a non matt or structured film with a thickness of 0.5 mm. The properties of the film (1) prepared according to the invention were compared with those of a film (2) of the same polycarbonate but without the addition of polystyrene.

Parts were punched out of films (1) and (2) which are used as a dial face in the tachometer of a passenger vehicle and contain a window approximately 1.5×4 cm² in size. The edges of this window remain visible and must therefore have an appropriate optical quality. The size of the burr was determined using a measuring microscope.

The following table shows the test results.

TABLE 1
Punching burrs

| Film | Punching burr in mm |
|---|---|
| (1) | 0.01-0.03 |
| (2) | 0.14-0.16 |

The following properties were measured on films (1) and (2):

mechanical (tensile test according to ISO 527):

tear strength

elongation at break

elasticity modulus

optical

yellowness index, ASTM E313 (C2°)

haze, ASTM D 1003

transmission, 0°/diffuse

thermal

shrinkage, in accordance with IEC 674

1 hour/120° C.

1 hour/150° C.

TABLE 2
Comparison of properties

| | | Tear | | Elong. at | | | | | | | |
|---|---|---|---|---|---|---|---|---|---|---|---|
| | | strength | | break | | E mod. | Yellow- | | Trans- | | |
| | % poly- | MPa | | % | | MPa | ness | Haze | mission | 1 h. 120° C. | 1 h 150° C. |
| Film | styrene | long. trans. | | long. trans. | | long. trans. | index | % | % | long. trans. | long. trans. |
| (1) | 10 | 61 | 61 | 92 | 73 | 2438/2355 | 0.65 | 0.8 | 89.7 | ≦0.1 | ≦0.15 |
| (2) | 0 | 75 | 70 | 166 | 152 | 2105/2056 | 0.6 | — | 90 | ≦0.2 | — |

The comparison shows that the film (1) according to the invention does not differ substantially from comparison film (2) in terms of its mechanical, optical and thermal properties. As table 1 shows, however, the size of the punching burr of the film (1) according to the invention is less than 20% of the comparison film (2).

1. A film of a mixture of polycarbonate and polystyrene, wherein the proportion of polystyrene in the mixture is 7 to 20 wt. %.

2. Multi-layer film, wherein at least one layer comprises a mixture of polycarbonate and polystyrene, in which the proportion of polystyrene is 7 to 20 wt. %.

3. A film according to one of claims 1 or 2, wherein the proportion of polystyrene in the mixture of polycarbonate and polystyrene is 8 to 15 wt %.

4. A film according to one of claims 1 or 2, wherein the proportion of polystyrene in the mixture of polycarbonate and polystyrene is 9 to 13 wt. %.

5. The use of the film according to any one of claims 1 to 4 for the manufacture of products from said films by punching.

6. A process for the manufacture of products from films according to any one of claims 1 to 4 by punching.

7. Products which may be obtained from films according to any one of claims 1 to 4 by punching.

8. Screen, dial, indicating dial, dial face, dial face of a vehicle tachometer or insertable part which may be obtained from films according to any one of claims 1 to 4 by punching.
